(19) United States
(12) Patent Application Publication
(10) Pub. No.: US 2010/0183402 A1
(43) Pub. Date: Jul. 22, 2010

(54) TAPPING NUT

(76) Inventor: CHING-JU TENG, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/355,791

(22) Filed: Jan. 18, 2009

(51) Int. Cl. F16B 37/00

(52) U.S. Cl. 411/436

(57) ABSTRACT

A tapping nut includes a cylindrical tunnel, a conical tunnel, a plurality of slits and a plurality of edges. The diameter of the cylindrical tunnel is marginally smaller than that of a bolt to be tapped by the tapping nut. The conical tunnel extends and expands from the cylindrical tunnel so that the bolt can be introduced into the cylindrical tunnel through the conical tunnel. The cutting edges are formed on an internal side of the tapping nut. Each of the cutting edges extends along a related one of the slits so that the cutting edges can cut the bolt while the slits allows the removing of debris of the bolt.

### BACKGROUND OF INVENTION

1. Field of Invention

The present invention relates to a nut and, more particularly, to a tapping nut.

2. Related Prior Art

A threaded bolt and nut are often used for fastening purposes. A thread is formed on the threaded bolt. A corresponding thread is formed on an internal side of the nut. Thus, the threaded bolt can be engaged with the nut. In consideration of smooth rotation on one hand, there is an appropriate clearance between the threads. In consideration of firm engagement on the other hand, there is provided a washer between the head of the threaded bolt and the nut or an additional nut against the nut. However, the washer often cannot ensure the firm engagement of the threaded bolt with the nut. Sometimes, there is no room for such an additional nut.

In some other times, the length of a threaded bolt can only be determined before it is used. In this case, a smooth bolt is made of an excessive length so that it can be cut to an appropriate length for use. Then, a tool is used to tap the smooth bolt with a thread so that a threaded bolt is made. It is however troublesome to carry such a tool. Moreover, it is a waste of time to use such a tool to tap the smooth bolt and then engage a nut with the threaded bolt.

The present invention is therefore intended to obviate or at least alleviate the problems encountered in prior art.

### SUMMARY OF INVENTION

It is the primary objective of the present invention to provide a nut for fast tapping of and firm engagement with a bolt.

To achieve the foregoing objective, the nut includes a cylindrical tunnel, a conical tunnel, a plurality of slits and a plurality of edges. The diameter of the cylindrical tunnel is marginally smaller than that of a bolt to be tapped by the tapping nut. The conical tunnel extends and expands from the cylindrical tunnel so that the bolt can be introduced into the cylindrical tunnel through the conical tunnel. The cutting edges are formed on an internal side of the nut. Each of the cutting edges extends along a related one of the slits so that the cutting edges can cut the bolt while the slits allows the removing of debris of the bolt.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a perspective view of a tapping nut according to the preferred embodiment of the present invention.

FIG. 2 is another perspective view of the tapping nut shown in FIG. 1.

FIG. 3 is a perspective view of a bolt and the tapping nut of FIG. 1.

FIG. 4 is a perspective view of the bolt tapped by the tapping nut shown in FIG. 3.

FIG. 5 is a perspective view of the bolt engaged with the tapping nut shown in FIG. 4.

FIG. 6 is a cross-sectional view of the bolt and the tapping nut shown in FIG. 4.

FIG. 7 is a cross-sectional view of the bolt and the tapping nut shown in FIG. 5.

### DETAILED DESCRIPTION OF PREFERRED EMBODIMENT

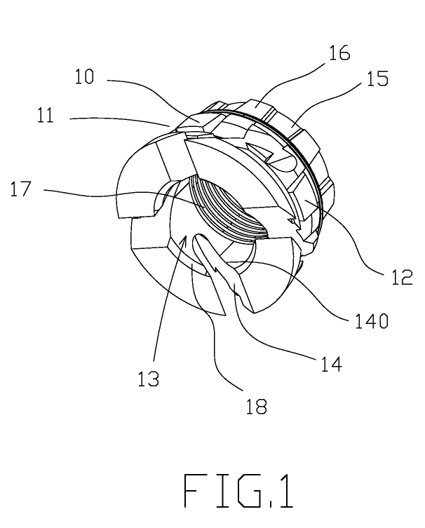

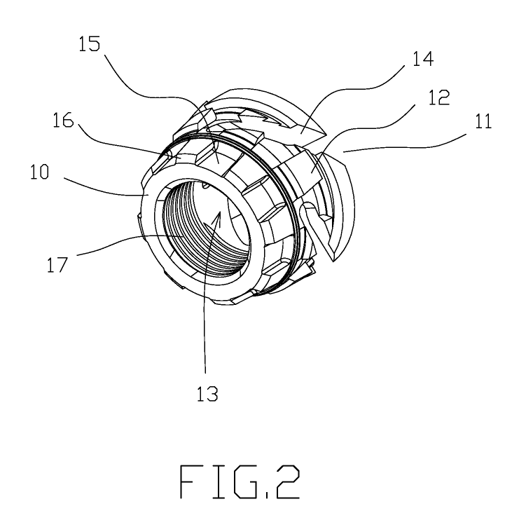

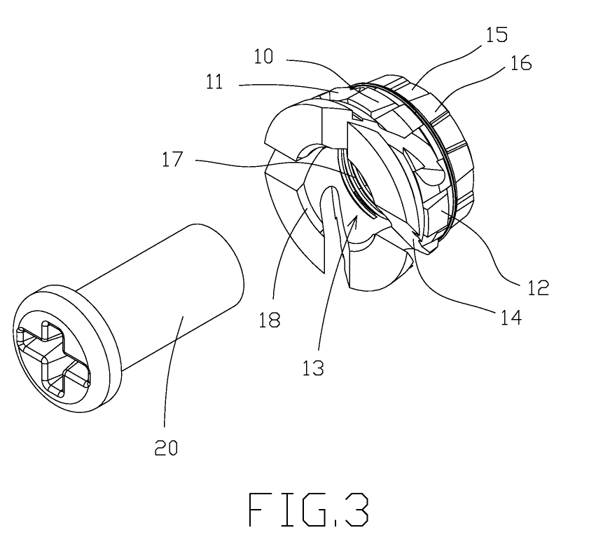

Referring to FIGS. 1 through 3, a tapping nut 10 includes a cylindrical portion 15 and a conical portion 11 extending and expanding from the cylindrical portion 15 according to the preferred embodiment of the present invention. The tapping nut 10 includes a cylindrical tunnel 13 therein and a conical tunnel 18 in communication with the cylindrical tunnel 13. The diameter of the cylindrical tunnel 13 is marginally smaller than that of a bolt 20 to be tapped by the tapping nut 10. The conical tunnel 18 extends and expands from the cylindrical tunnel 13.

The conical portion 11 is in the form of a conical frustum. There are four slits 14 cut into the conical portion 11. The slits 14 are in the form of a segment of a helix. Four cutting edges 140 are formed on an internal side of the conical portion 11. Each of the cutting edges 140 extends along a related one of the slits 14. The cutting edges 140 are used to tap a thread 25 on the bolt 20. Debris of the bolt 20 can be removed through the slits 14. A plurality of blocks 12 is formed on an external side of the conical portion 11. The blocks 12 can be disposed in corresponding recesses defined in a tool that is operable to rotate the tapping nut 10.

A thread 17 is formed on an internal side of the cylindrical portion 15. The thread 17 is used for engagement with the thread 25. A plurality of blocks 16 is formed on an internal side of the cylindrical portion 15. The blocks 16 can be disposed in corresponding recesses defined in the tool that is operable to rotate the tapping nut 10. The blocks 16 and the blocks 12 are preferably alternately arranged.

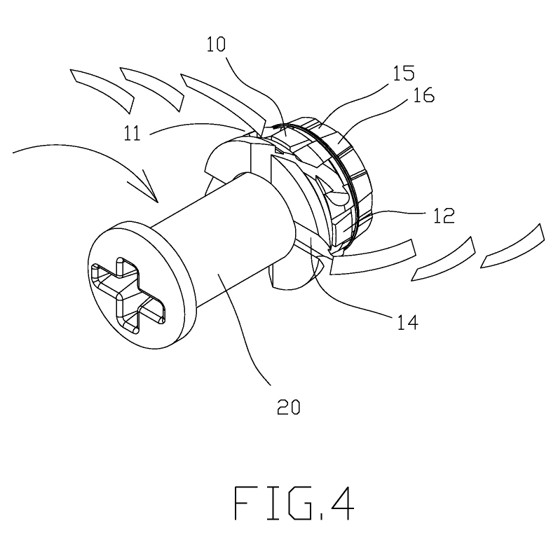

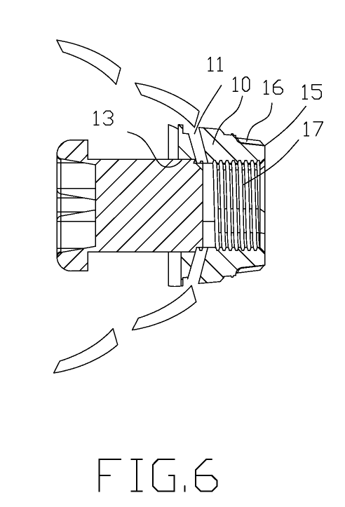

Referring to FIGS. 4 and 6, the bolt 20 is inserted in the conical tunnel 18 so that the bolt 20 is in contact with the cutting edges 140. The tapping nut 10 is rotated on the bolt 20 so that the cutting edges 140 tap the bolt 20 with the thread 25. Debris of the bolt 20 is removed through the slits 14 and does not interfere with the tapping.

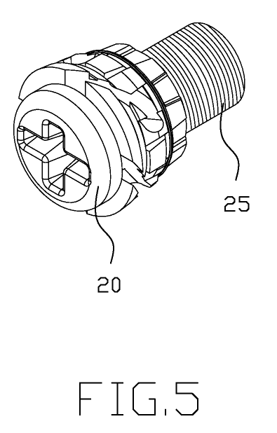

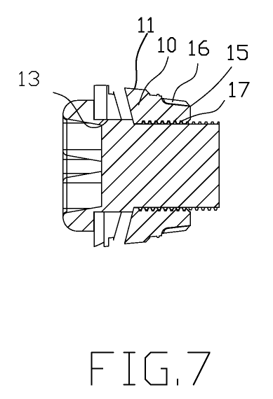

Referring to FIGS. 5 and 7, the taping nut 10 is further rotated relative to the bolt 20 so that the thread 17 is engaged with the thread 25. As discussed above, the tapping of the bolt 20 by the tapping nut 10 is smooth and fast while the engagement of the tapping nut 10 with the bolt 20 is firm.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A tapping nut comprising:
a cylindrical tunnel therein and with a diameter marginally smaller than that of a bolt to be tapped by the tapping nut;
a conical tunnel extending and expanding from the cylindrical tunnel so that the bolt can be introduced into the cylindrical tunnel through the conical tunnel;
a plurality of slits therein; and
a plurality of cutting edges formed on an internal side, wherein each of the cutting edges extends along a related one of the slits so that the cutting edges can cut the bolt while the slits allows the removing of debris of the bolt.

2. The tapping nut according to claim 1 comprising a cylindrical portion and a conical portion extending and expanding from the cylindrical portion.

3. The tapping nut according to claim 2, wherein the cylindrical portion comprises a plurality of blocks for insertion in recesses in a tool.

4. The tapping nut according to claim 2, wherein the conical portion comprises a plurality of blocks for insertion in recesses in a tool.

5. The tapping nut according to claim 2, wherein the cylindrical portion comprises a plurality of blocks for insertion in recesses in a tool, and the conical portion comprises a plurality of blocks for insertion in other recesses in the tool, and the blocks of the cylindrical portion and the blocks of the conical portion are alternately arranged.

6. The tapping nut according to claim 1 comprising a thread on an internal side for engagement with the thread of the bolt.
